(19) United States
(12) Patent Application Publication
(10) Pub. No.: US 2025/0156369 A1
(43) Pub. Date: May 15, 2025

(54) APPLIANCES AND METHODS TO PROVIDE ROBUST COMPUTATIONAL SERVICES IN ADDITION TO A/V ENCODING, FOR EXAMPLE AT EDGE OF MESH NETWORKS

(71) Applicant: VIDEON CENTRAL, INC., State College, PA (US)

(72) Inventors: Todd A. Erdley, State College, PA (US); Paul C. Brown, Port Matilda, PA (US)

(21) Appl. No.: 18/774,311

(22) Filed: Jul. 16, 2024

Related U.S. Application Data
(63) Continuation of application No. 17/837,509, filed on Jun. 10, 2022, now abandoned.
(60) Provisional application No. 63/210,174, filed on Jun. 14, 2021.

(51) Int. Cl. G06F 15/78; G06F 9/50

(52) U.S. Cl. CPC G06F 15/7807; G06F 9/5072

(57) ABSTRACT

An appliance includes a system on chip (SOC) and converter. The appliance accepts A/V data (e.g., HDMI®, SDI®, IP) from external sources, encodes A/V data using an encoder of the SOC and performs additional services via other computational components of the SOC. The SOC may be a mobile SOC. The appliance may operate as an edge appliance, edge encoder, or edge-based origin-server, for instance at an edge endpoint of a mesh network, allowing many-to-many distribution of A/V data, performing computationally efficient A/V encoding, while also making available additional computational resources (e.g., cycles of CPUs, GPUs, DSPs, AI/ML NPUs) to provide other services at the edge in addition to efficient A/V encoding.

### TECHNICAL FIELD

The present disclosure relates generally to audio, visual and/or audiovisual (collectively A/V) encoders used to encode A/V streams, and in particular to systems, methods and articles that provide computationally efficient A/V encoding of A/V data from sources external to the appliance while providing computational resources (e.g., cycles of central processing units (CPUs), graphics processing units (GPUs), digital signal processors (DSPs), artificial intelligence (AI)/machine learning (ML) neural processing units (NPUs)) of a system on chip (SOC) for providing other services, for instance at an edge endpoint of a mesh network.

### BACKGROUND

### Description of the Related Art

Conventional A/V encoders that accept A/V data from external sources typically take the form of dedicated, single purpose, appliances with operations typically limited to A/V encoding.

Numerous makes and models of systems on chip (SOC) are commercially available, each providing a mix of circuitry designed to address specific types of computational operations. The specific circuitry is typically referred to as processing units, processors, or modules, and may, for example include one or more central processing units (CPUs) with one or more cores, graphics processing units (GPUs), digital signal processors (DSPs), artificial intelligence (AI)/machine learning (ML) neural processing units (NPUs), A/V encoders, modems, power conditioners, etc. In operation, the SOC will employ different sets of circuitry for executing sets of operations dependent on the type of operations to be performed and/or the type data on which the operations will be performed. For example, certain signal processing operations may be executed via a DSP of the SOC, while certain graphic operations executed via a GPU of the SOC, A/V encoding operations executed by an encoder of the SOC, and more general operations executed by one or more cores of a CPU of the SOC.

There has been significant development of mobile SOCs which are commonly designed for use in smartphones, tablet computers and wearable computers. Examples of SOCs include various versions of the Qualcomm Snapdragon® processor, the Apple MI® processor, the various versions of the Nvidia Tegra® processor, and/or the various versions of the Samsung Exynos® processor.

As video-based social media applications (e.g., Snap Chat®, YouTube®, TIKTOK®) have become increasingly popular, the video encoding capabilities of mobile SOCs for mobile devices (e.g., smartphones) have greatly improved, encompassing extremely low powered mobile SOCs with dedicated encoders that perform A/V encoding. Typically, these mobile SOCs include an accelerated pipeline (e.g., MIPI CSI® pipeline) between a high quality camera or image sensor and the encoder. In operation, when the encoder becomes aware that A/V data is present, the encoder establishes encoding parameters via control circuitry and programming in the mobile SOC. When ready to receive the A/V data, the encoder requests the A/V data, thus employing a pull mode architecture where the encoder pulls A/V data from the image sensor or related buffer via the accelerated pipeline, and then efficiently performs A/V encoding.

Notably, many of the sets of circuitry in an SOC, other than the CPU and GPU, tend to be fixed in that those sets of circuitry may be controllable but typically are not reprogrammable. Thus, for example, an A/V encoder algorithm as implemented in the structure of the circuitry of an encoder of an SOC is typically fixed.

### BRIEF SUMMARY

Mobile SOCs are extremely energy efficient (e.g., with a maximum power draw of equal to or less than 30 Watts), offer a wide variety of specialized set of modules and thus computational flexibility, are highly reliable, provide for computationally efficient A/V encoding, and due to the economies of scale provide very good value (e.g., computational flexibility and computational operations per unit of time) for cost (e.g., dollars) as compared to more specialized SOCs. The use of mobile SOCs, and other SOCs that offer a wide range of computational flexibility along with computationally efficient A/V encoding, in appliances would be advantageous with respect to computational flexibility, reliability, and cost or value. However, as noted above, mobile SOCs are typically designed to pull A/V data from a camera or image sensor integrated in the mobile device (e.g., smartphone).

It would be useful to provide an appliance that includes a system on chip (SOC), the appliance which accepts A/V data from sources external to the appliance and which encodes A/V data using an encoder of the SOC and which perform additional services via other computational components of the SOC.

The SOC may advantageously be a mobile SOC having specifications sufficient for use in smartphones. Use of a mobile SOC and/or an FPGA can advantageously improve a power to watt ratio as compared to conventional desktop and/or laptop processors or FPGAs.

The computational components can, for example include one or more of: central processing units (CPUs) with one or more cores, one or more graphics processing units (GPUs), one or more digital signal processors (DSPs), and/or one or more artificial intelligence (AI)/machine learning (ML) neural processing units (NPUs).

The appliance can, for example, receive at least one of: High Definition Multimedia Interface (HDMI®) A/V data, Serial Digital Interface (SDI®) A/V data, Internet Protocol (IP) A/V data, Network Device Interface (NDI) A/V data, or Society of Motion Picture and Television Engineers (SMPTE) 2110 A/V data from a source that is external to the appliance and supply corresponding A/V data to the A/V encoder of the SOC. The appliance can, for example, include a convert that converts the received A/V data from one format to another format, for example converting an HDMI® stream to an MIPI CSI® stream. The converter can, for example, supply the converted A/V data to the encoder via an accelerated pipeline, for instance pushing the converted A/V data to the A/V encoder via the accelerated pipeline of the SOC via one or more Mobile Industry Processor Interface (MIPI®) Camera Serial Interfaces (CSIs).

The video pipeline on mobile SOCs is camera sensor based (i.e., pulls from camera sensor). The describe appliances can, at least in some implementations, implement a modified pipeline to enable video to be pushed from external video source (e.g., HDMI®/SDI®/IP {NDI, 2110, . . . }) into the SOC, efficiently using ISPs and GPUs instead of the processor (e.g., CPU) of the SOC.

Techniques and structures described herein may advantageously free up processing cycles of the CPUs, GPUs, CPUs, DSPs and AI/ML NPUs of the SOC. Freeing up processing cycles of the GPUs, CPUs, DSPs and AI/ML NPUs of the SOC may provide a platform for added value through pre-integrated applications and/or application programming interfaces (APIs). Such may, for instance, be particularly advantageous in preforming streaming, especially streaming of live sports. Such may, for instance, be particularly advantageous in broadcast, especially as broadcasting moves to ATSC 3.0 hybrid broadcast/unicast services. For instance using core ASSP (Application Specific Standard Parts) module of an SOC for core functionality (Video and Audio Encode), can advantageously free up processing cycles of the GPUs, CPUs, DSPs and AI/ML NPUs of the SOC, enabling serverless and/or container based edge compute, and/or AL/ML Inferences to be run at an endpoint edge. In one example, the freed up processing cycles may be employed to perform image stitching, for example stitching 2K frame videos together to produce 4K UHD frame video. This is just one of various advantages that can be realized using the described appliances and methods.

Such may, be particularly advantageous in enhancing the user experience. For example, such can provide noise reduction and other PQ enhancements; provide for insertion of welcome user relevant advertisements; provide offers for user retention; perform speech to text conversion, for instance where subtitles are absent; perform text to alternate language text translations for unserved language speakers; perform face recognition, for instance to facilitate second screen experiences (e.g., IMDb® data); and/or perform metadata processing, for instance to generate purchasing cues or prompts.

Such may, be particularly advantageous in enhancing a service business model. For example, such can reduce bandwidth consumption through efficient encoding; lower encoding costs through selective formats, for instance for “hot” content; provide low cost/high quality service and thereby lower customer acquisition cost; provide enhanced content recommendation, for example via VionLabs or Think Analytics integration; provide targeted advertising served from edge origin through Think Analytics integration; lower customer churn through Evergent or ThinkAnalytics integration; and/or provide or facilitate second screen services thereby generating an additional revenue stream.

The additional services may, for example, include executing: AI applications, workflow applications, applications that edit the video stream (cut, splice, insert, overlay, etc.), applications that enhance the video or audio (e.g., backlight, backgrounds), applications that adjust encoding parameters (bit rate, regions, etc.), applications that read or write metadata streams, video/audio stream processing applications, security and privacy applications, and/or customer or end user compute functions.

It would be useful to provide an appliance at an edge appliance, edge encoder, or edge-based origin-server, for instance at an edge endpoint of a mesh network, allowing many-to-many distribution of A/V data, where the appliance performs computationally efficient A/V encoding, while also advantageously providing additional computational resources (e.g., cycles of CPUs, GPUs, DSPs, AI/ML NPUs) to provide other services at the edge in addition to efficient A/V encoding. Locating an appliance at an endpoint of an edge as an origin server advantageously achieves low latency in content delivery. For example, the described appliances may be advantageously located at the actual source of the A/V data or origination (e.g., the end point).

It would also be useful to implement a set of guiderails or constraints to ensure that computational tasks are within the computational capabilities of the SOC prior to performing such computational tasks.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIGS. 1A and 1B are a schematic diagram of an appliance according to at least one illustrated implementation, the appliance including a system on chip (SOC) and a converter in the form of a field programmable gate array (FPGA), the SOC which includes an audio-visual (A/V) encoder and other computational resources, and the converter which is operable to convert A/V data form an external source of A/V data external to the appliance and push the converted A/V data to the encoder which performs A/V encoding, the SOC which also provides other computational services in addition to A/V encoding.

FIG. 2 is a schematic diagram illustrating a mapping of computational services across various components of a system on chip (SOC) and converter of an appliance according to at least one illustrated implementation, where the appliance takes the form of a low power video data center at an edge endpoint, for instance an edge-based origin-server.

FIG. 3 is a schematic diagram illustrating a system architecture for a portion of an appliance which receives an incoming stream of audio-visual (A/V) data in a first format, converts the A/V data to a second format, and A/V encodes the converted A/V data, according to one illustrated implementation.

FIG. 4 is a schematic diagram of an appliance in the form of an edge-based origin-server located at an endpoint of an edge of a network (e.g., mesh network) that provides A/V encoding and offers additional computational services in addition to the A/V encoding, according to one illustrated implementation.

FIG. 5 is a flow diagram showing a method of operating an appliance, according to at least one illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, act, components, processors, etc. In other instances, well-known structures associated with systems on chip (SOCs), central processing units (CPUs), graphics processing units (GPUs), digital signal processors (DSPs), artificial intelligence (AI)/machine learning (ML) neural processing units (NPUs), buses, pipelines, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

High-Definition Multimedia Interface (HDMI®) is an audio/video interface for transmitting uncompressed video data and/or compressed or uncompressed digital audio data from an HDMI®-compliant source device to a compatible computer monitor, projector, digital television or digital audio device, typically over a single cable. As used herein and in the claims HDMI® includes HDMI® 1.0, HDMI® 1.1, HDMI® 1.2 HDMI® 1.4, HDMI® 2.0, and HDMI® 2.1.

Serial Digital Interface (SDI®), High-Definition Serial Digital Interface (HD-SDI®), and Ultra-High-Definition Serial Digital Interface (UHD-SDI®) are a family of digital video interfaces as of Jun. 1, 2021, standardized by Society of Motion Picture and Television Engineers (SMPTE). Such typically use one or more coaxial cables with a nominal impedance of 75 Ohms and with BNC connectors.

The headings and Abstract of the Disclosure provided herein are for convenience only and do not interpret the scope or meaning of the implementations.

Described herein are various implementations of an appliance, for example an edge encoder, an edge processing platform or edge-based origin-server, which can provide efficient A/V encoding of A/V data for sources external to the appliance and provide computational services in addition to the A/V encoding, which are denominated herein as additional computational services. In some implementations, the appliance includes a system on chip (SOC) and converter. The SOC can advantageously take the form of a mobile SOC, that is an SOC having specifications and/or performance characteristics that make such suitable for use in mobile devices, and in particular in smartphones.

The techniques and structures described herein can partition functions onto embedded hardware blocks on SOC. Partitioning advantageously protects performance, for instance SOC performance to provide services in addition to A/V encoding. For example, color space conversion can be partitioned to a GPU and/or image processor. Also for example, image stitching can be partitioned to a GPU. Also for example, deinterlacing can be partitioned to a Video Pre Processor (VPP). Also for example, encryption can be partitioned to a dedicated security processor (e.g. fuse region).

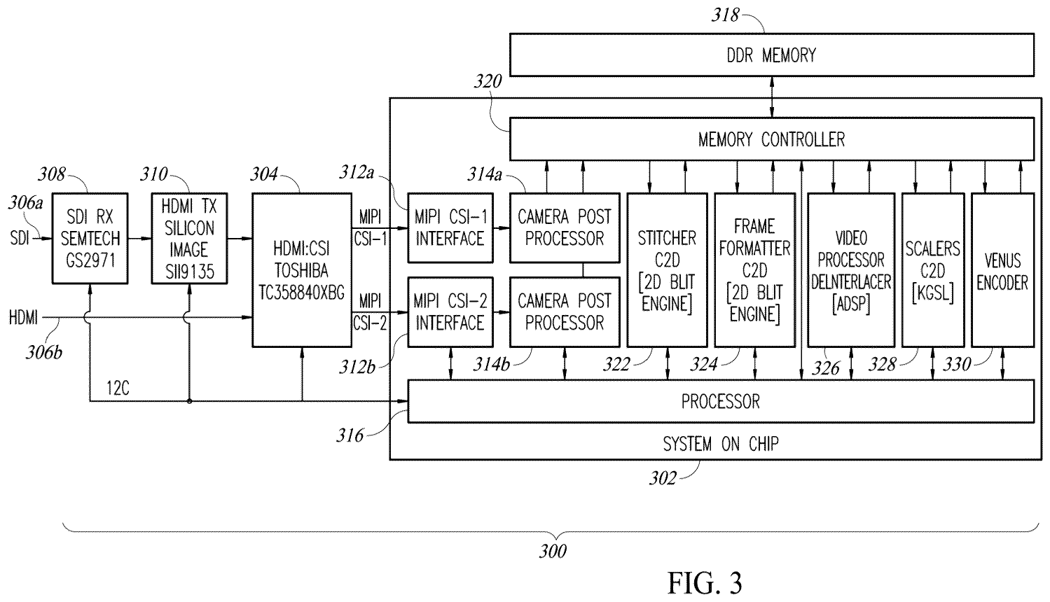

Described herein are techniques and structures or architectures that advantageously utilize a pull-based camera encoder for processing and encoding push-based video. Described herein are techniques and structures or architectures that advantageously implement stream timestamp synchronization for some implementations (e.g., those that employ bridge converter such as that illustrated in FIG. 3). Described herein are techniques and structures or architectures that employ a converter to handle diverse input formats and that advantageously employ an FPGA-based system to handle diverse input formats.

Described herein are techniques and structures or architectures that advantageously implement an edge-based origin-server for low-latency stream monitoring. Described herein are techniques and structures or architectures that advantageously utilize lambda functions and containerized applications to interact with the capture, processing, encoding, packaging and delivery of a plurality of video, audio and metadata streams. Described herein are techniques and structures or architectures that advantageously implement a cloud-based application store and on-device component manager for audio and video processing components that understands how to ‘glue’ them together seamlessly to create a custom installation.

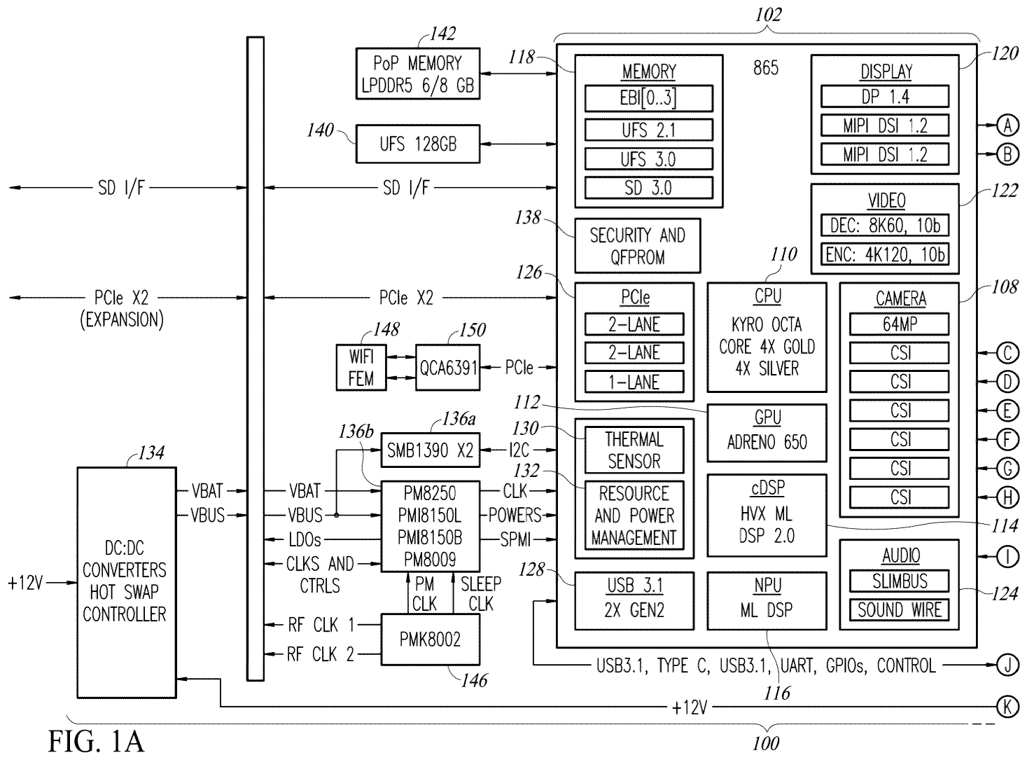

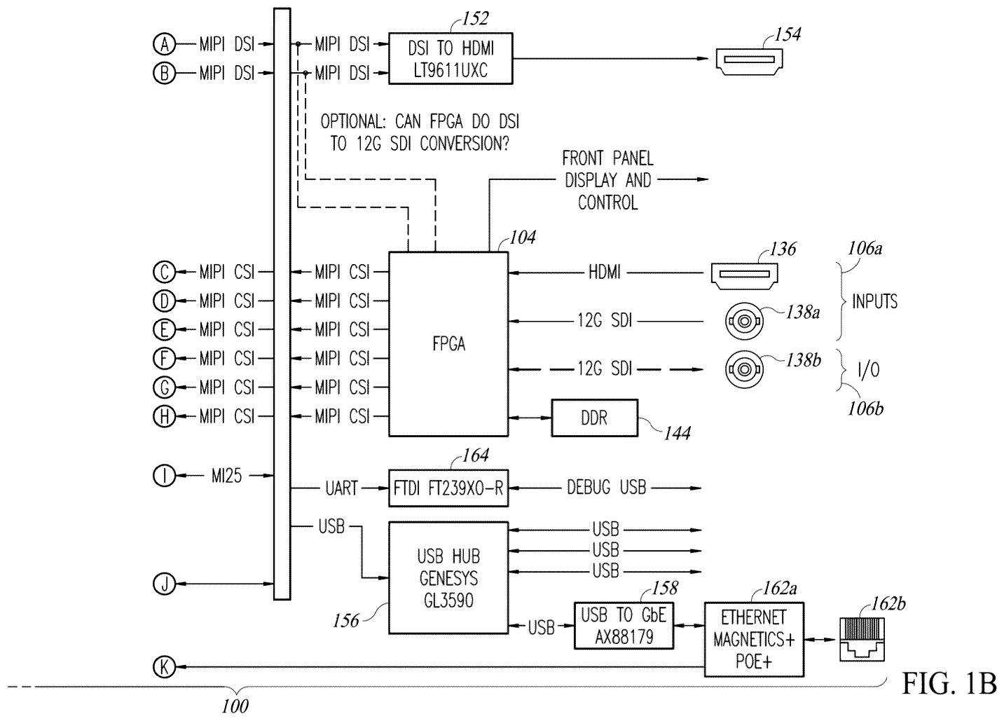

FIGS. 1A and 1B show an appliance 100 according to one illustrated implementation, that performs audio-visual (A/V) encoding and that provides other computational services in addition to A/V encoding.

The appliance 100 include a system on chip (SOC) 102, a converter 104, and other components. As an overview, the converter 104 is operable to convert A/V data received from one or more external sources of A/V data 106a, 106b (i.e., sources of A/V data that are external to the appliance 100), and to supply the converted A/V data to an A/V encoder 108 which performs A/V encoding. The various components and operations of the illustrated appliance 100 are discussed below.

The SOC 102 may take a variety of forms, although mobile SOCs which are designed for use in mobile (e.g., smartphones) are particularly suitable as set out in the Summary section of this application. Such mobile SOCs typically include a wide variety of computational units, processors or modules, A/V encoding circuitry, have low power consumption (e.g., equal to or less than 30 Watts) and typically operate without active cooling (e.g., fanless).

The SOC 102 includes one or more camera post processors 108 and one or more computational components. The computational components can, for example include one or more of: central processing units (CPUs) 110 with one or more cores, one or more graphics processing units (GPUs) 112, one or more digital signal processors (DSPs) 114, one or more artificial intelligence (AI)/machine learning (ML) neural processing units (NPUs) 116 and/or memory 118.

The SOC 102 also includes an optional display controller 120. The optional display controller 120 can, for example provide an HDMI® signal to an external device for presentation of A/V media.

The SOC 102 includes an A/V encoder, for example in the form of a video encoder 122 and an audio encoder 124.

The video encoder 122 can perform video encoding, or part of it, as this video encoding can be complemented with video encoding at a different operation or point in the process (e.g., CPU post-processing). The video encoder 122 can, for example, take the form of dedicated video encoder circuitry on the SOC 102. Use of a dedicated video encoder module can advantageously reduce or even completely avoid the use CPU cycles. The video encoder 122 can, for example, provide H.264 & H.265 support and/or CBR & VBR support. The video encoder 122 can, for example, support multiple renditions, for instance up to 4KP30 or 4KP60 Tussey Platform. The video encoder 122 can, for example, provide full ABR ladder support. The video encoder 122 can, for example, provide support 10 bit sampling with Tussey Platform. Providing for multiple renditions (Variants) eliminates the need for a cloud Transcoder at the endpoint, thereby improving latency and reducing cost.

The audio encoder 124 can perform audio encoding, or part of it, as this audio encoding can be complemented with audio encoding at a different operation or point in the process (e.g., CPU post-processing). The audio encoder 124 can, for example, take the form of dedicated audio encoder circuitry on the SOC 102. For instance, the audio encoder 124 can, for example, be implemented as an AAC Encoder on a dedicated DSP. The audio encoder 124 can, for example, perform AAC-LC encoding (up to 6-channels). The audio encoder 124 can, for example, accommodate CBR and VBR bitrates. Advantageously, other CODECS can be supported using the edge compute capability provided by the appliance 100.

The SOC 102 may also include a PCIe bus controller 126 and USB bus controller 128 to provide communications.

The SOC 102 may also include one or more thermal sensors 130 and a resource and power management module 132 communicatively coupled to receive power from a DC: DC converter 134 of the appliance 100 via power control circuitry 136a, 136b (e.g., one or more commercially available amplifiers or power integrated circuit modules, for instance PM8250, PM18150L, PM18150B, PM8009) of the appliance 100.

The SOC 102 may further include a security module 138, for example including a fuse region which can be used to store disk encryption keys (e.g., QFPROM) to secure data in the SOC 102.

The converter 104 is illustrated in FIG. 1B as a field programmable gate array (FPGA), however can take other forms, for example a bridge converter chip 304 as illustrated in FIG. 3. The converter 104 is operable to convert A/V data received from one or more external sources of A/V data 106a, 106b, which are external to the appliance 100, and supply the converted A/V data to the A/V encoder 108 which performs A/V encoding. For example, the converter 104 may receive at least one of: High Definition Multimedia Interface (HDMI®) A/V data, Serial Digital Interface (SDI®) A/V data, Internet Protocol (IP) A/V data, Network Device Interface (NDI) A/V data, or Society of Motion Picture and Television Engineers (SMPTE) 2110 A/V data from an external source 106a, 106b that is external to the appliance 100 and supply corresponding A/V data to the A/V encoder 108 of the SOC 102. The converter 104 can, for example, receive HDMI® signals from an external source 106a (i.e., external to the appliance 100) via an HDMI® cable 136, receive SDI® signals from an external source 106a, 106b (i.e., external to the appliance 100) via an SDI® cable 138a, 138b, and/or receive as input from an external source (i.e., external to the appliance 100) or send as output to the external source 106b as SDI® signals via an SDI® cable 138b.

The converter 104 can, for example, convert a received HDMI® stream to an MIPI CSI® stream. In at least some implementations, the converter 104 supplies the converted A/V data to the SOC 102 (e.g., the camera post processors 108 via interfaces) by pushing the converted A/V data to the SOC 102, rather than having the SOC 102 (e.g., camera post processor(s), video and/or audio encoders) pull the converted A/V data as would be more typical of a conventionally operated mobile SOC. While it is possible to have one or more components (e.g., CPU) of the SOC 102 execute instructions to essentially cause the video encoder 122 and audio encoder 124 to encode A/V data pushed to the SOC 102, such disadvantageously tends to overwhelm the component(s) (e.g., CPU) of the SOC 102, consuming a large percentage, if not almost all, of the processing cycles of the component, leaving such unavailable to provide other computational services.

The appliance 100 may, for example, include additional memory, for instance flash memory 140 (e.g., UFS 128 GB) and/or random access memory 142 (RAM, e.g., LPDDR5 6/8 GB) each communicatively coupled to the memory 118 of the SOC 102. The appliance 100 may, for example, include additional memory, for instance RAM 144 (e.g., DDR SDRAM) communicatively coupled to the converter 104.

The appliance 100 may, for example, include a clock circuit 146 (e.g., PMK8002) to provide a clock signal to the SOC 102.

The appliance 100 may, for example, include a WLAN front end module (WIFI FEM) 148 and radio module 150 (e.g., QCA6391 from Qualcomm), communicatively coupled to the PCIe controller 126 of the SOC 102.

The appliance 100 may, for example, one or more converters 152 operable to convert output A/V data. For example, the appliance 100 may include a high performance MIPI DSI/CSI to HDMI2.0 converter 152 for STB, DVD applications (e.g., LT9611UXC converter commercially available from Lontium Semiconductor Corporation). The converter(s) 152 can be communicatively coupled to the display controller 120, and can provide an HDMI® signal to an external device via an HDMI® cable 154.

The appliance 100 may, for example, include a USB hub 156 (e.g., Genesys GL3590) to provide for bi-directional communications with one or more external devices. The appliance 100 may, for example, include a USB 3.0 to Gigabit Ethernet controller 158 (e.g., AX88179 commercially available from ASIX Electronics Corporation) coupled between the USB hub 156 and an Ethernet cable 162a with an associated Ethernet connector 162b, the Ethernet cable 162a and associated Ethernet connector 162b which can provide communications and power (Power over Ethernet or POE).

The appliance 100 may optionally include UART driver 164 (e.g., FT239X-R) from Future Technology Devices International Limited) to allow debugging.

The appliance 100, and in particular the SOC 102, provides other computational services in addition to A/V encoding, the other computational services referred to herein as additional computational services. For example, the converter 104 may allow use of the A/V encoder of the SOC 102 without significantly impacting one or more of the other resources of the SOC 102, allowing those other resources (e.g., CPUs 110 with one or more cores, GPUs 112, DSPs 114, AI/ML NPUs 116 and/or memory 118) to be used to provide additional computational services, as described elsewhere herein.

While specific components are identified in the illustration, those represent components that can be suitable for an exemplary embodiment, and the claims are not intended to be limited to any specific make/model of component unless a make/model are expressly recited in the claim. For example, while FIGS. 1A and 1B illustrate a specific example of a suitable CPU 110 (KYRO OCTA CORE 4X Gold, 4X Silver), any of a variety of CPUs can be employed. Likewise, any of a variety of GPUs 112 and memory 142 can be employed, not just the illustrated Adreno 650 CPU and the illustrated LPDDR5 RAM.

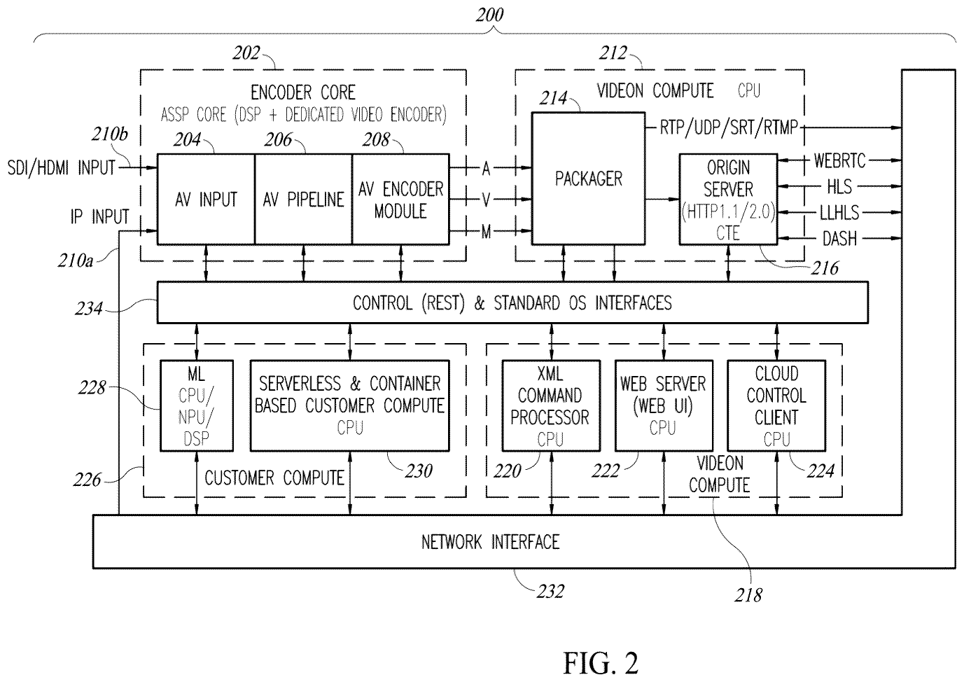

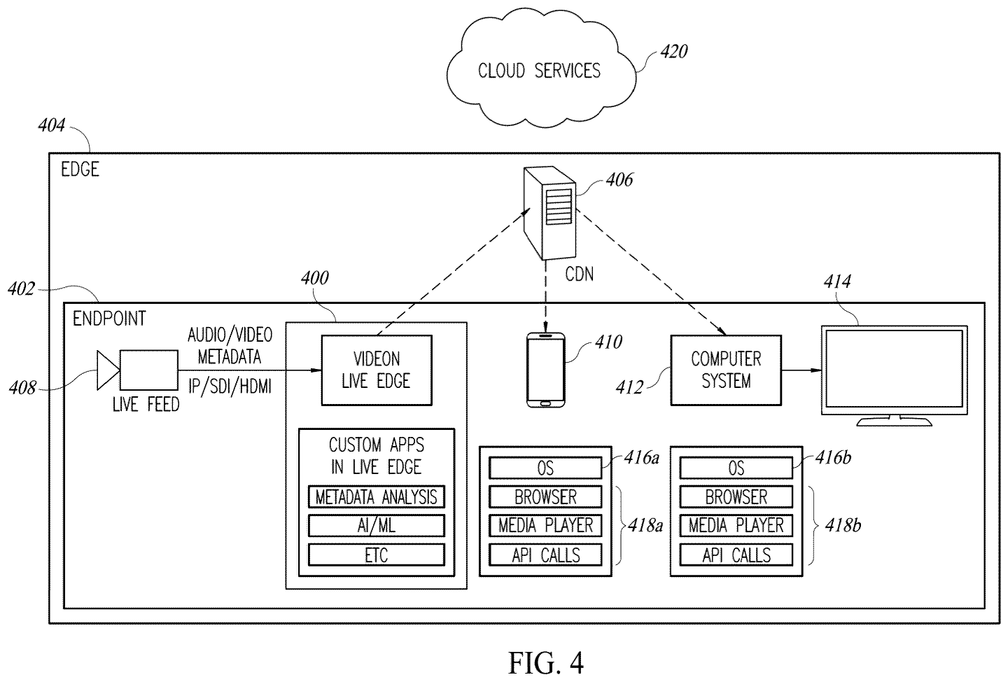

FIG. 2 illustrates a mapping of computational services across various components of an SOC and converter of an appliance 200, according to at least one illustrated implementation. The appliance 200 can, for example take the form of the appliance 100 (FIGS. 1A and 1B). The SOC can, for example take the form of the SOC 102 (FIG. 1). The converter can, for example take the form of the converter 104 (FIG. 1B) or other converter (e.g., converter 304 of FIG. 3). The appliance 200 can take the form of a low power video data center at an edge endpoint, for instance an edge-based origin-server 400 (FIG. 4).

The appliance 200 includes an encoder core 202 operable to convert A/V data form the external source and perform A/V encoding. The encoder core 202 can be comprised by an AV input module 204, A/V pipeline 206, and an A/V encoder module 208. The AV input module 204 can, for example, take the form of a converter, for example the converter 104 (FIG. 1B) or other converter (e.g., converter 304 of FIG. 3). The A/V pipeline 206 can, for example, take the form of an accelerated pipeline (e.g., MIPI CSI pipeline). The A/V encoder module 208 can, for example, take the form of dedicated A/V encoder circuitry (e.g., video encoder 122, audio encoder 124 of FIG. 1A) and/or one or more processors (e.g., DSP 114 of FIG. 1A). The encoder core 202 can receive A/V data for one or more external sources, that is from sources that are external to the appliance 200. For instance, the encoder core 202 can receive A/V data as IP input 210a and/or HDMI or SDI input 210b and or, as illustrated in FIG. 2.

The appliance 200 includes an A/V compute module 212, which for instance can be implemented via a CPU (e.g., CPU 110 of FIG. 1A) and/or implemented via one or more other components of an SOC (e.g., implemented by GPUs 112, DSPs 114, AI/ML NPUs 116 of FIG. 1A). The A/V compute module 212 provides A/V related functions beyond the A/V encoding.

The A/V compute module 212 can, for instance, implement a packager 214 which enables a wide variety of standard streaming outputs to be produced or provided by the appliance 200. The packager 214 can, for example, provide TS Outputs: RTP/UDP/SRT. The packager 214 can, for example, provide RTMPx3 output. The packager 214 can, for example, provide HTTP based outputs including, for instance: DASH manifests supporting Low Latency Modes (CTE); HLS Manifests; Apple LL-HLS Manifests; FMP4/TS Support. The packager 214 can, for example, provide output to an internal Origin Server as well as to external Origin Servers (e.g., Dual Posting for redundancy). The packager 214 can, for example, generate a local record.

The A/V compute module 212 can, for instance, implement an origin server 216 in which the server is located at the origin of the A/V data capture or origination. The origin server 216 can, for example, handle or implement HTTP 1.1/2.0. The origin server 216 can, for example, handle or implement various streaming protocols, for instance: HLS; DASH; Low Latency DASH; and Apple LL-HLS protocols. The origin server 216 can, for example, handle or implement Chunk Transfer Encoding (CTE). The origin server 216 can, for example, handle or implement Open Range Requests as per RFC8673. The origin server 216 can, for example, handle or implement WEBRTC. The origin server 216 can, for example, be tested with various major CDNs (e.g., Akamai, Fastly, Amazon Cloudfront, Limelight, Edgecast or Edgio).

The appliance 200 includes an appliance compute module 218, which for instance can be implemented via a CPU (e.g., CPU 110 of FIG. 1A) and/or implemented via one or more other components of an SOC (e.g., implemented by GPUs 112, DSPs 114, AI/ML NPUs 116 of FIG. 1A). The A/V compute module 218 allows customers, operators or end users of the appliance 200 to access the computational resources of the appliance, for example to obtain manufacturer specified additional services at the edge endpoint in addition to A/V encoding. The appliance compute module 218 can, for instance, implement an XML command processor 220. The XML command processor 220 can, for example, be simple command and/or status processor polling based. The appliance compute module 218 can, for instance, implement a Web Server 222. The Web Server 222 can, for instance, be a local Web Server that serves local WebUI. The appliance compute module 218 can, for instance, implement a cloud control client 224. The cloud control client 224 can, for instance, provide an IOT device interface to a cloud control system.

The appliance 200 includes a customer compute module 226, which for instance can be implemented via a CPU (e.g., CPU 110 of FIG. 1A) and/or implemented via one or more other components of an SOC (e.g., implemented by GPUs 112, DSPs 114, AI/ML NPUs 116 of FIG. 1A). The customer compute module 226 allows customers, operators or end users of the appliance 200 to access the computational resources of the appliance, for example to obtain customer, operator or end user specified additional services at the edge endpoint in addition to A/V encoding. The customer compute module 226 can, for instance, make available computational resources 228 to execute applications loaded or specified by customer, operator or end user to obtain various additional services, for instance specific to a customer, operator or end user of the appliance 200. The customer compute module 226 can, for instance, provide native language support for Python 3.7.9, Go Lang, and/or Node.js. The customer compute module 226 can, for instance, provide serverless and container based customer compute 230, for instance via the CPU. For example, customer compute module 226 can provide Docker support.

The appliance 200 can include one or more network interfaces 232 as well as one or more control (REST) and operating system interfaces 234. For example, a REST API can, for example, control the appliance core encoder 202 (e.g., Videon Core Encoder), the packager 214 and/or the Origin Server(s) 216. An associated core API may include a REST API, XML Poll, a data socket for Encoder Bulk Data and/or a data socket for AI/ML metadata.

The appliance 100, 200 (FIGS. 1A, 1B and 2) may implement one or more AI/ML inference engines. Such can, for example utilize AI/ML NPUs (e.g., via Qualcomm Snapdragon® Neural Processing Engine SDK). The AI/ML inference engine(s) may be designed and/or trained off device. The resulting inference model(s) can be converted to execute on the appliance. For example, one or more AI/ML inference models may be loaded to the appliance 100, 200. The appliance 100, 200 can then run the AI/ML inference model locally on the appliance, for example at an endpoint of an edge or edge-based origin-server. Support may, for example, be provided for Caffe, Caffe2, ONNX, and/or TensorFlow.

FIG. 3 shows a system architecture for a portion of an appliance 300 which receives an incoming stream of audio-visual (A/V) data in a first format, converts the A/V data to a second format, and A/V encodes the converted A/V data, according to one illustrated implementation.

As an overview, an A/V pipeline may include video data, audio data and optionally metadata, which may be split for processing and encoding. The video pipeline can handle any current forms of video data (e.g., HDMI or SDI or IP video data standards in effect as of Jun. 1, 2021. The audio pipeline can, for example, support 8-channel audio input and/or channel grouping (e.g., stereo-pairs).

The portion of the appliance 300 employs an SOC 302, and a bridge converter chip 304 in contrast to the FPGA 104 illustrated in FIG. 1B. The bridge converter chip 304 receives A/V data, for example SDI® A/V data 306a and/or HDMI® A/V data 306b, IP A/V data, etc. The bridge converter chip 304 can take a variety of forms, for instance an HDMI® to CSI converter (e.g., TC358840XBG converter commercially available from Toshiba). The bridge converter chip 304 can receive the SDI® A/V data 306a via a receiver 308 (e.g., a 3G-SDI, HD-SDI, SD-SDI and DVB-ASI Integrated Receiver with SMPTE Audio/Video Processing and Integrated Adaptive Cable Equalizer commercially available as Semtech GS2971 or Semtech GS2971A from Semtech) and an HDMI® transmitter 310 (e.g., commercially available as SiI9135 transmitter; SiI9136 transmitter from Silicon Image, Inc.). The receiver 308 passes the received SDI® A/V data 306a to the HDMI® transmitter 310 which in turn transmits the SDI® A/V data 306a to the SOC 302. The bridge converter chip 304 converts the received A/V data, for example SDI® A/V data and/or HDMI® A/V data, into, for example MIPI CSI® A/V data (e.g., a stream of MIPI CSI® A/V data).

In particular, SDI® A/V data 306a can be received by the SDI integrated receiver 308 (e.g., Semtech GS2971A multi-rate SDI integrated Receiver which includes complete SMPTE processing). In at least some implementations, the SDI® integrated receiver 308 splits the SDI A/V data 306a, for example, into a Video Stream (e.g., 20 bit Video), an Audio Stream (e.g., I2S) and a Metadata Stream (e.g., SPI). The HDMI® transmitter 310 (e.g., SiI9135 transmitter; SiI9136 transmitter) converts the output of the SDI® integrated receiver 308 into an HDMI® signal.

An SOC receives the converted A/V data from the bridge converter chip 304 via one or more interfaces to the SOC 302, for example, via a pair of MIPI CSI® interfaces 312a, 312b.

In particular, when in a 4K input mode the output of the HDMI® transmitter and the HDMI® Input of the edge device can be converted into 2 MIPI CSI® interfaces 312a, 312b by using the HDMI® to CSI® converter (e.g., TC358840XBG converter commercially available from Toshiba®). When in an input mode that is less than 4K Input mode the HDMI® to CSI® converter (e.g., TC358840XBG converter commercially available from Toshiba) only utilizes a single MIPI CSI® Interface. When in an input mode greater than a 4K Input mode the HDMI® to CSI® converter (e.g., TC358840XBG converter commercially available from Toshiba) can utilize two or more MIPI CSI® Interfaces 312a, 312b. The appliance can autonomously employ intelligent determination of the number of MIPI CSI® interfaces 312a, 312b to be used and intelligent selection of the MIPI CSI® interfaces 312a, 312b from a plurality of MIPI CSI® interfaces 312a, 312b.

The SOC 302 may include or implement a number of processors, for example a pair of camera post processors 314a, 314b. The camera post processors 314a, 314b handle color space conversion, for example without the intervention of the system processor 316 of the SOC 302. For example, camera post processors 314a, 314b can perform color space conversion to BT.601 or BT.709 (full or limited) depending on input resolution from other HDMI®-supported color formats. The camera post processors 314a, 314b send the processed input video frames to a system memory 318 (e.g., DDR memory) via a memory interface 320 (e.g., memory controller) of the SOC 302. The system memory 318 can be memory that is integral to the SOC 302 (e.g., memory 118 of FIG. 1A) or that is separate from and communicatively coupled to the SOC 302 (e.g., flash memory 140 (e.g., UFS 128 GB) and/or random access memory 142 of FIG. 1A).

The SOC 302 may include or implement a stitcher 322, for example via a GPU of the SOC 302. For example, when operating in a 4K input mode, the GPU stitches two input video frames together to create a single 4K input frame. When operating in a 1080P input mode or lower input modes this process is not run. All video frames are stored in system memory 318 (e.g., DDR memory) via a memory interface 320 (e.g., memory controller).

The SOC 302 302 may include or implement a video frame formatter 324, for example via a GPU of the SOC 302. For example, when the input is interlaced the video frame formatter 324, running on the GPU, formats the video frames or fields into the format required by a video deinterlacer 326.

The SOC 302 may include or implement a video processor deinterlacer 326, for example via a DSP of the SOC 302. For example, the video processor deinterlacer 326, running on a dedicated DSP block, reads two interlaced fields via the memory interface 320 and converts those fields into a single progressive frame and stores the resulting single progressive frame in system memory 318. For example, deinterlacing via a video processor deinterlacer 326 implemented in dedicated hardware and/or a DSP may advantageously reduce the computational load on the CPU of the SOC, freeing the CPU to perform other application processing. To implement such the camera pipeline in SD820 is modified to pass a field identifier from the input to deinterlacer. Such can, for example, use Hollywood Quality Video (Silicon Optics HQV) processing for deinterlacing via the DSP.

The SOC 302 may include or implement one or more video scalers 328, for example via a GPU of the SOC 302. For example, the video scalers 328, running on the GPU, reads the video frame from system memory 318 and scales the video frame to the desired resolution. Multiple video scalers (up to the total Encode bandwidth) can run simultaneously or concurrently. For example, the scalers 328 may perform multi-stage video frame scaling in the GPU, advantageously reducing the computational load on the CPU of the SOC, freeing the CPU to perform other application processing.

The SOC 302 may include or implement a video encoder 330 (e.g., Venus video encoder), for example as dedicated video encoder circuitry on the SOC 302. For example, the video encoder 330 reads the scaled video frames from system memory 318 and compresses the video frames to either H.264 or H.265 streams using dedicated video encode hardware.

Notably, the system processor 316 builds audio/video/metadata pipelines. Once the pipelines are built, the system processor 316 only handles low bandwidth functions including pipeline and A/V synchronization monitoring.

A mobile SOC's reference software typically pulls data from an image or camera sensor that is part of the mobile device (e.g., smartphone). In at least some implementations, appliances described have modified the operation of the appliance to accept data pushed from external sources (e.g., Internet Protocol (IP), Network Device Interface (NDI), Society of Motion Picture and Television Engineers (SMPTE) 2110 standard, Serial Digital Interface (SDI®) and High Definition Multimedia Interface (HDMI®)). In at least some implementations, appliances described herein can utilize embedded GPUs to, for instance take a 4K input as 2 streams and stitches the images together without the use of the system processor (CPU), thus saving power, and CPU cycles. Other implementations can use the system processor (CPU) to perform stitching, which consumes relatively large amounts of power and CPU cycles.

To achieve such, in at least some implementations (e.g., those that employ bridge converter such as that illustrated in FIG. 3), the appliances described herein can advantageously perform A/V pipeline synchronization. Since the SOC architecture expects to be video master, audio, video and/or metadata (A/V&M) synchronization from external masters (e.g. IP, SDI®, HDMI®) is a challenge.

The appliance can implement a system level synchronizer that synchronizes audio, video and metadata, for example using the audio (if available) as a master.

The system level synchronizer can, for example, compute audio and video clock correction factors from arrival time. The system level synchronizer can, for example, perform a linear least mean square regression (e.g., over an 8 second window). The system level synchronizer can, for example, determine a weighted moving average (e.g., over a 20 second window). The system level synchronizer can, for example, compute an approximate difference (i.e., delta) between the local clock timestamps and the individual streams, for instance using the smoothed data.

The appliance (e.g., that employs a bridge converter such as that illustrated in FIG. 3) can implement or include a stream synchronizer filter. For example, as deltas in the synchronizer approach one access unit, timestamp deltas are updated. Update buffer timestamps with deltas. Will cause Video Frame filter to actually drop a frame or duplicate frame to bring streams in alignment. If the input signal's audio, video, and metadata are properly locked, the Video Frame filter is not activated.

The appliance can perform ancillary data extraction to different stream types (e.g., SMPTE-2038 and/or CEA-708 (608)) to video elementary stream user data. It is noted that “ancillary data” can, for example, include ancillary data related to closed captions or other non-audio/video data that employs time stamping. The data timestamp synchronization can be based on dependency to associated video frames timestamps.

A/V data paths for all sources into pre-processing units (such as scalers, frame-rate converters, etc.) is the same no matter the original source (e.g. SDI®, HDMI® or audio). This reduces complexities and overall effort for developing new features and maintainability.

FIG. 4 is a schematic diagram of an appliance in the form of an edge-based origin-server 400 located at an endpoint 402 of an edge 404 of a network 406 (e.g., mesh network, content delivery network (CDN)), the edge-based origin-server 400 operable to provide A/V encoding and to offer additional computational services, in addition to the A/V encoding, according to one illustrated implementation. The edge-based origin-server 400 can take the form of the appliances 100, 200 (FIGS. 1A, 1B and 2) and/or include the portion of the appliance 300 (Figure), or can take other forms.

Locating the edge-based origin-server 400 at the edge 404, and particularly at the endpoint 402 of the edge 404 advantageously achieves low latency in content delivery. For example, the various implementations of the appliances described herein may be advantageously located at an actual source of the A/V data or origination (e.g., the end point), for example collocated with a video camera 408. The edge-based origin-server 400 can process and A/V encode the AV data (e.g., video, audio and/or metadata) captured by the video camera 408, for example using the various structures, methods and techniques described herein.

The edge-based origin-server 400 can provide (e.g., stream) the encoded AV data to one or more recipient processor-based devices, for example a smartphone 410 and/or computer system 412 with a communicatively coupled display or monitor 414. The term computer as used herein includes any terminal device that has display capabilities, including for instance a smartphone, a tablet, or a A/R or VR headset. In at least some implementations, the edge-based origin-server 400 provides the encoded AV data to the smartphone 410 and/or computer system 412 via the network 406 (e.g., CDN).

As described here, the edge-based origin-server 400 can provide additional computational services in addition to the A/V encoding.

The smartphone 410 and/or computer system 412 each have respective processors (e.g., microprocessors) and memory (e.g., ROM, RAM, FLASH). The smartphone 410 and/or computer system 412 each have a respective operating system 416a, 416b and a respective set of applications 418a, 418b (e.g., sets of processor-executable instructions). The operating system 416a, 416b and applications 418a, 418b can be stored in memory and executed by the processors.

In at least some implementations, the smartphone 410 and/or computer system 412 can access to the edge-based origin-server 400, for example via a cloud based portal 420. The smartphone 410 and/or computer system 412 can execute one or more of the applications 418a, 418b to access or request additional services from the edge-based origin-server 400. Such can, in at least some implementations, be implemented as API calls to the edge-based origin-server 400. Any of a large variety of additional computational services may be accessed, at least some of which are described elsewhere herein.

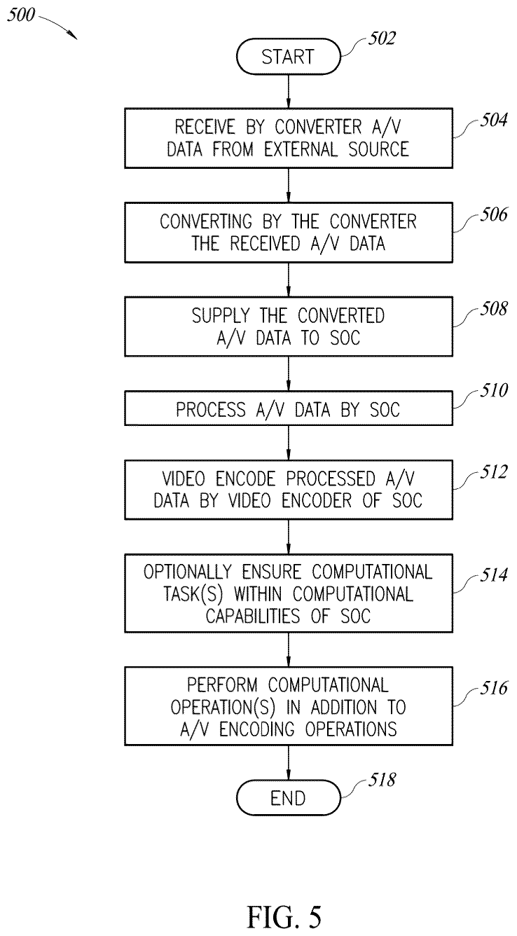

FIG. 5 shows a method 500 of operating an appliance (e.g., appliance 100 of FIGS. 1A, 1B, appliance 200 of FIG. 2), according to at least one illustrated implementation.

The method may start at 502, for example in response to a powering ON event, a user input, receipt of A/V data or commands, or an invocation from a calling routine.

At 504, a converter of the appliance receives A/V data from a source that is external to the appliance. For example, the converter may receive at least one of: High Definition Multimedia Interface (HDMI®) A/V data, Serial Digital Interface (SDI) A/V data, Internet Protocol (IP) A/V data, Network Device Interface (NDI) A/V data, or Society of Motion Picture and Television Engineers (SMPTE) 2110 A/V data from a source that is external to the appliance.

At 506, the converter converts the received A/V data. For example, the converter may convert one or more of High Definition Multimedia Interface (HDMI®) A/V data, Serial Digital Interface (SDI®) A/V data, Internet Protocol (IP) A/V data, Network Device Interface (NDI) A/V data, or Society of Motion Picture and Television Engineers (SMPTE) 2110 A/V data to a different format, for example to a MIPI CSI® format. The converter may, for example, split the SDI A/V data 306a, for example, into a Video Stream (e.g., 20 bit Video), an Audio Stream (e.g., I2S) and a Metadata Stream (e.g., SPI).

At 508, the converter supplies the converted A/V data to the SOC. For example, the converter may push a stream of MIPI CSI® A/V data to the SOC via one or more MIPI CSI® interfaces.

At 510, various components of the SOC can process the A/V data. For example, camera post processors, stitcher, frame formatter, video processor deinterlacer and/or scalers may process the A/V data as described above, dependent on the type and/or format of the A/V data.

At 512, a video encoder of the SOC encodes the processed A/V data.

Optionally at 514, the SOC determines whether one or more computational tasks that are to be performed by the SOC are within the computational capabilities of the SOC before performing computational operations to carry out the computational tasks. These computational tasks are in addition to the AV encoding operations performed by the appliance. These computational tasks may be previously stored on the appliance, or may be requested (e.g., requested in real-time) by a customer, operator or end user of the appliance. These computational tasks may be related to A/V data (e.g., performing facial recognition, license plate recognition, facial blurring) or may be completely unrelated to the A/V data.

At 514, the appliance performs one or more computational operations in addition to operations executed in performing the AV encoding. For example, at least one of: the CPU, the one or more GPUs, one or more DSPs, and/or one or more AI/ML NPUs of the SOC execute one or more computational operations in addition to operations executed in performing the AV encoding. These computational tasks may be previously stored on the appliance, or may be requested (e.g., requested in real-time) by a customer, operator or end user of the appliance. These computational tasks may be related to A/V data (e.g., performing facial recognition, license plate recognition, facial blurring) or may be completely unrelated to the A/V data.

The method 500 may terminate at 518, for example until invoked again. Alternatively, the method 500 may repeat to pick or retrieve additional specimen containers from the array of specimen containers.

Applications for the apparatus, articles and methods described herein include the following broad categories: AI applications, workflow applications, applications that edit the video stream (cut, splice, insert, overlay, . . . ), applications that enhance the video or audio (e.g., backlight, backgrounds), applications that adjust encoding parameters (bit rate, regions, . . . ), applications that read or write metadata streams, including time-bounded metadata synchronized with the content” (i.e. KLV metadata), video/audio stream processing applications, security and privacy applications.

AI applications may, for example, include any one or more of: face recognition creating metadata used for search (or security) data; NLU audio analysis to create metadata, automatic real time sub-title creation and enable real time language switching with lip synchronization optimization; object recognition, e.g., to enable product placement advertising: overlay bounding box/link for influencers; automated parental control by scene based recognition algorithms; artifact recognition and removal; automatic blurring for instance face blurring, license plate blurring, for instance useful in for news gathering; pose detection; and/or scene based emotion measurement to optimize target ad insertion and search functions.

Workflow applications may, for example, include any one or more of: metadata capture through local Web, cloud Web, or Smartphone data entry (e.g., require names of each person in scene before recording); metadata creation, harmonization and management; workflow management directly from device (e.g., submission and progress monitoring of video after capture (e.g., success versus retake message from server); automatic metadata capture through custom applications and connected devices (e.g., GPS location, WiFi and Bluetooth proximity, natural lighting sensors, lighting equipment sensing); and/or Uses: Custom “Serverless” functions (aka AWS Link+Subsplash) and/or containerized applications.

Stream editing applications may, for example, include any one or more of: targeted advertising insertion; and/or manifest management, for instance to enable adaptive bit rate optimization.

Applications that enhance video and/or audio may, for example, include any one or more of: background blur, room noise removal, etc.; and/or subject tracking (e.g., receive 4KP60 as input and output 1080P region of interest (ROI) that moves based on specified criteria). Applications can use externally sourced or AI/ML-based generated content to add metadata content to an audio/video streams, for example: player tracking in a sport event, speed of the ball, real-time bidding odds, etc.

Encoding control applications may, for example, include any one or more types of region of interest (ROI) encoding, for instance encoding of faces, lips, etc.

Security applications may, for example, include any one or more of: piracy prevention/intervention through forensic watermarking insertion; end-to-end bit stream encryption; and/or tamper-proof signatures for fake detection.

Metadata read and/or write applications may, for example, include EIDR detection and insertion.

The previously described applications are intended to be illustrative and not limiting. Other application can be implemented using the apparatus, articles and methods described herein.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various implementations described above can be combined to provide further implementations. To the extent that they are not inconsistent with the specific teachings and definitions herein, all of the U.S. patents, U.S. patent application publications, U.S. patent applications, foreign patents, foreign patent applications and non-patent publications referred to in this specification, are incorporated herein by reference, including U.S. Ser. No. 63/210,174, filed Jun. 14, 2021, in their entirety. Aspects of the implementations can be modified, if necessary, to employ systems, circuits and concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. An appliance, the appliance comprising:
a system on chip (SOC) comprising at least one central processing unit (CPU), at least one audio-visual (A/V) encoder that, in use performs AV encoding operations, and at least one of: one or more graphics processing units (GPUs), one or more digital signal processors (DSPs), one or more artificial intelligence (AI)/machine learning (ML) neural processing units (NPUs);
a converter that communicatively couples a source that is external to the appliance to the A/V encoder of the SOC and that is operable to receive Serial Digital Interface (SDI®) A/V data as input and to receive at least one of: High Definition Multimedia Interface (HDMI®) A/V data, or Internet Protocol (IP) A/V data that supports Network Device Interface (NDI) A/V data, or Society of Motion Picture and Television Engineers (SMPTE) 2110 A/V data, as input, from the source that is external to the appliance and supply corresponding A/V data to the A/V encoder of the SOC,
wherein the SOC has an accelerated pipeline to the A/V encoder of the SOC and the converter supplies the corresponding A/V data to the A/V encoder via the accelerated pipeline of the SOC.

2. (canceled)

3. The appliance of claim 2 wherein the converter pushes the corresponding A/V data to the A/V encoder of the SOC via the accelerated pipeline of the SOC.

4. The appliance of claim 3 wherein the converter pushes the corresponding A/V data to the A/V encoder of the SOC via the accelerated pipeline of the SOC via one or more Mobile Industry Processor Interface (MIPI®) Camera Serial Interfaces (CSIs).

5. The appliance of claim 1 wherein the converter comprises at least one field programmable gate array that converts an HDMI® stream to an MIPI CSI® stream.

6. The appliance of claim 1 wherein the converter comprises a bridge converter that converts an HDMI® stream to an MIPI CSI® stream.

7. The appliance of claim 1 wherein the SOC comprises at least one each of: one or more GPUs, one or more DSPs, one or more AI/ML NPUs.

8. The appliance of claim 7 wherein the appliance is an edge encoder.

9. The appliance of claim 7 wherein the appliance comprises an edge-based origin-server in a form of an audio video metadata content server.

10. The appliance of claim 7 wherein the appliance is at an edge endpoint of a mesh network.

11. The appliance of claim 7 wherein at least one of the CPU, the one or more GPUs, one or more DSPs, one or more AI/ML NPUs performs computational operations within a container-based computer environment available to third parties, in addition to the AV encoding operations performed by the encoder of the appliance.

12. The appliance of claim 11 wherein at least one of the CPU, the one or more GPUs, one or more DSPs, one or more AI/ML NPUs performs one or more A/V editing, A/V enhancing operations, or other A/V stream processing on the A/V data in addition to the A/V encoding operations performed by the encoder of the appliance.

13. The appliance of claim 11 wherein at least one of the CPU, the one or more GPUs, one or more DSPs, one or more AI/ML NPUs performs one or more operations that adjust encoding parameters of the encoding in addition to the A/V encoding operations performed by the encoder of the appliance.

14. The appliance of claim 11 wherein at least one of the CPU, the one or more GPUs, one or more DSPs, one or more AI/ML NPUs executes one or more AI operations, workflow operations, in addition to the A/V encoding operations performed by the encoder of the appliance.

15. The appliance of claim 11 wherein at least one of the CPU, the one or more GPUs, one or more DSPs, one or more AI/ML NPUs executes one or more applications that read or write metadata streams, in addition to the A/V encoding operations performed by the encoder of the appliance.

16. The appliance of claim 11 wherein at least one of the CPU, the one or more GPUs, one or more DSPs, one or more AI/ML NPUs executes one or security and privacy applications or customer or end user compute functions, in addition to the A/V encoding operations performed by the encoder of the appliance.

17. The appliance of claim 11 wherein the SOC ensures that one or more computational tasks are within the computational capabilities of the SOC before at least one of the CPU, the one or more GPUs, one or more DSPs, one or more AI/ML NPUs performs computational operations in addition to the AV encoding operations performed by the encoder of the appliance.

18. (canceled)

19. The appliance of claim 1 wherein the SOC is a mobile class SOC and has a maximum power consumption of no more than 30 Watts and the appliance is fanless having no fans.

20. (canceled)

21. A method operation of an appliance the appliance comprising a system on chip (SOC) and a converter communicatively coupled to the SOC, the SOC comprising at least one central processing unit, at least one audio-visual (A/V) encoder that, in use performs AV encoding operations, and at least one of: one or more graphics processing units (GPUs), one or more digital signal processors (DSPs), one or more artificial intelligence (AI)/machine learning (ML) neural processing units (NPUs), the method comprising:
receiving, by the converter, of the appliance Serial Digital Interface (SDI®) A/V data as input and receiving at least one of: High Definition Multimedia Interface (HDMI®) A/V data, or Internet Protocol (IP) A/V data that supports Network Device Interface (NDI) A/V data, or Society of Motion Picture and Television Engineers (SMPTE) 2110 A/V data from a source that is external to the appliance; and
converting, by the converter, the received Serial Digital Interface (SDI®) A/V data and the received High Definition Multimedia Interface (HDMI®) A/V data, or Internet Protocol (IP) A/V data that supports Network Device Interface (NDI) A/V data, or Society of Motion Picture and Television Engineers (SMPTE) 2110 A/V data to corresponding A/V data;
supplying, by the converter, the corresponding A/V data to the A/V encoder of the SOC;
encoding, by the A/V encoder of the SOC, the corresponding A/V data; and
performing, by the at least one of the CPU, the one or more GPUs, one or more DSPs, one or more AI/ML NPUs, one or more computational operations within a container-based computer environment available to third parties, in addition to the AV encoding operations performed by the encoder of the appliance.

22. (canceled)

23. The method of claim 21 wherein supplying the corresponding A/V data to the A/V encoder of the SOC includes pushing the corresponding A/V data to the A/V encoder via an accelerated pipeline of the SOC via one or more Mobile Industry Processor Interface (MIPI®) Camera Serial Interfaces (CSIs).

24.-29. (canceled)

30. The method of claim 21, further comprising:
ensuring, by the SOC, that one or more computational tasks are within the computational capabilities of the SOC before performing computational operations in addition to the AV encoding operations performed by the encoder of the appliance.
